(19) United States
(12) Patent Application Publication
(10) Pub. No.: US 2010/0138240 A1
(43) Pub. Date: Jun. 3, 2010

(54) Data for Use of Accessible Computer Assisted Detection

(76) Inventors: David Leib, Bet Shemesh (IL); Jonathan Stoeckel, RB Hierden (NL)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/623,813

(22) Filed: Nov. 23, 2009

Related U.S. Application Data
(60) Provisional application No. 61/118,523, filed on Nov. 28, 2008.

(51) Int. Cl. G06Q 50/00; G06K 9/00

(52) U.S. Cl. 705/3; 382/128

(57) ABSTRACT

Computer assisted detection (CAD) is made accessible to more medical offices. The CAD is provided as a service. Customers gain access to CAD service through a computer network but without the purchase of expensive software and/or hardware. The customers use software for extracting needed patient data to use the CAD service. The CAD service provider uses a server farm or third party server facilities, allowing growth without as substantial upfront costs. The CAD service provider collects patient data by providing the service. The aggregated patient data allows training of different or improved CAD algorithms. The service also identifies suspect data, such as associated with incorrect imaging settings, and provides help to the customers.

### RELATED APPLICATIONS

The present patent document claims the benefit of the filing date under 35 U.S.C. §119(e) of Provisional U.S. Patent Application Ser. No. 61/118,523, filed Nov. 28, 2008, which is hereby incorporated by reference.

### BACKGROUND

Computer Assisted Detection (CAD) assists medical professionals in diagnosis of patients based on data. For example, CAD assists in identifying and/or diagnosing suspect locations in a medical image. CAD may operate as a second reviewer, providing more efficient and reliable second review. However, a CAD system may be expensive (e.g., tens of thousands of dollars), limiting the availability of CAD workstations to larger medical institutions. For the CAD system developer, future revenues and growth may be limited due to workstation costs. Clinical trials may verify CAD usefulness, but clinical trials are expensive, limiting revenue.

### SUMMARY

In various embodiments, systems, methods, instructions, and computer readable media are provided for accessible computer assisted detection. The CAD is provided as a service. Customers, such as medical offices, gain access to CAD service through a computer network but possibly without the purchase of expensive software and/or hardware. The customers use software for extracting needed patient data to use the CAD service. The CAD service provider may use a server farm or third party server facilities, possibly allowing for growth as needed with reduced upfront costs. The CAD service provider may collect patient data by providing the service. The patient data may allow for training of different or improved CAD algorithms. The service may result in aggregation of an otherwise unavailable training data set. The service may also identify suspect data, such as associated with incorrect imaging settings, and provide help to the customers. Any one or more of the features described above may be used alone or in combination.

In a first aspect, a computer readable storage medium has stored therein data representing instructions executable by a programmed processor for accessible computer assisted detection. The instructions include receiving patient information for a patient; extracting computer assisted detection information from the patient information, the computer assisted detection information being free of data identifying the patient; assigning, to the computer assisted detection information, an identification unrelated to the data identifying the patient; transmitting the computer assisted detection information with the assigned identification to a computer assisted detection service; receiving results from application of the computer assisted detection to the computer assisted detection information, the results being different than the transmitted computer assisted detection information; and associating the results with the patient by the identification.

In a second aspect, a method for accessible computer assisted detection is provided. An image signature process is received from a computer assisted detection service. The image signature process is associated with obtaining the computer assisted detection remotely from the computer assisted detection service. The image signature process is installed on a local computer having access to patient data. The image signature process is configured for stripping the patient data of patient identity information and at least some information not used by the computer assisted detection, maintaining at least one image of the patient in the patient data, associating an identifier with the patient data, transmitting the patient data, including at least one image and excluding the patient identity information, and the identifying to a computer assisted detection service, receiving results from application of the computer assisted detection to the patient data by the computer assisted detection service, the results including the identifier but free of the at least one image, matching the results with the at least one image and the patient, and displaying a modified image, the modified image corresponding to the at least one image with result information.

Any one or more of the aspects described above may be used alone or in combination. These and other aspects, features and advantages will become apparent from the following detailed description, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for accessible computer assisted detection; and

FIG. 2 is a flow chart diagram of one embodiment of a method for accessible computer assisted detection.

### DETAILED DESCRIPTION OF THE DRAWINGS and Presently Preferred Embodiments

A new computer assisted detection (CAD) approach or computer network is provided. Computer assisted detection may be made more accessible. An entity, such as a computer assisted detection developer or designer, provides a computer assisted detection service. The service is provided over a computer network and/or remote from a location of viewing, scanning, treatment, and/or diagnosis. For example, the service provider runs the computer assisted detection system on a third party server farm.

Medical data is acquired at each of a plurality of facilities at the same or different times. Any type of medical data, such as imaging, genetic, clinical, test results, or family history, may be used for CAD. For imaging data, any one or more of different types of medical imaging data, such as x-ray, computer tomography, magnetic resonance, ultrasound, or positron emission, may be used. In one embodiment, mammography and/or chest x-rays are acquired for breast and/or lung cancer screening.

The acquired data is submitted to a remote server through a network, such as the Internet. The remote server receives information from the different facilities. The remote server applies a CAD algorithm or other process (e.g., image analysis or alignment). Any of various processes are requested either automatically or through user input. In response to either a direct message (e.g., an inserted request code), an implicit message based on the type of data transmitted to the server, or a predefined agreement between the local facility and the server, processing by the server is requested. The server processes the data, such as applying a CAD algorithm. The processing occurs automatically or in conjunction with medical professional input.

The results of the processing are then transmitted back to the appropriate local facilities, such as transmission over the Internet. The results may then be used at each of the various local facilities as part of the diagnosis. The results may also be sent to a facility other than the one from which the data was originally received. The communications and processes occur in real-time during a patient examination or at different times for later diagnosis assistance. All or part of the communication can be encrypted to ensure privacy.

Using a remote CAD service may allow for large market penetration and provide continuous and stable revenues to the CAD service provider. Extraction of information may limit bandwidth constraints on a remote CAD service. Use of rented or third party servers may allow the CAD service provider to focus on the CAD algorithm without maintenance associated with operating servers. The customer data aggregated as part of providing the service may allow for collection of more training data, possibly allowing better machine training for later CAD algorithms. The CAD service may provide other services, such as operation verification based on the data from the customers.

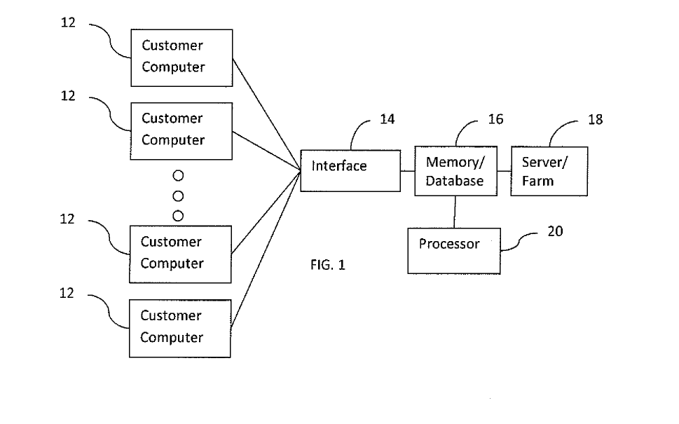

FIG. 1 shows one embodiment of a system for accessible computer assisted detection. Pluralities of customer computers 12 connect through a network to an interface 14. Any number of customer computers 12 representing a same or different number of customers may be used. The interface 14 is for a server 18 and database 16. A processor 20, such as another server, of the CAD service provider has access to the database 16 and/or the server 18. The customer computers 12, processor 20, and/or server 18 may have associated memories, displays, and/or user interfaces. Additional, different or fewer components may be provided for the system. For example, the interface 14 is integrated with the database 18 or server 18. As another example, the server 18 connects with the interface 14 for processing patient information and separately connects with the memory 16 for storage of data received by the server 18.

The customer computers 12 are personal computers, workstations, or imaging systems. Any type of computing system may be used. The customer computers 12 may include local area networks, such as a network at a hospital, and an associated server and memory for accessing image data. In alternative embodiments, one or more of the customer computers 12 are laptop computers, personal digital assistants (PDA), or cellular phones. Different types of computers may be used for different ones of the customer computers 12, such as a PACS workstation at one medical office and an imaging system at another medical office.

Two or more customer computers 12 are provided, such as tens, hundreds, or any other number. Each customer computer 12 is associated with a different location or facility (e.g., different medical office). For example, each customer computer 12 is associated with a clinic or hospital in a different building, in a different city and/or different state. The customer computers 12 are provided at medical offices, such as a hospital, clinic, doctor's office, doctors home, medical administration, or other locations. The medical offices are customers of the CAD service provider. More than one customer computer 12 may be available in a same medical office or facility. In one embodiment, the system is adapted to work world wide so that any of the customer computers 12 are at various locations and facilities throughout the world. Country or region specific implementations may also be provided. In one embodiment, one or more of the customer computers 12 include a plurality of imaging systems at a single facility with or without associated workstations and local area networking. Others of the customer computers 12 represent an individual computer, such as at a clinic. Yet others of the customer computers 12 represent portable, such as hand-held or movable computers, that are connectable with the interface 14. The customer computers 12 may be located in mobile vehicles, such as emergency response vehicles, airborne crafts, seaborne crafts or submersible crafts. Any combination of all of the same types, different types, same manufacturer, different manufacturer or other characteristics are provided for the customer computers 12 for different locations and associated different facilities.

The customer computers 12 have access to patient information. The CAD service may be provided for 2D, 3D, or 4D imaging or other digital processing (e.g., processing based, at least in part, on clinical data and/or genetic information). Little or no additional bandwidth is required from users. The users likely have high-speed Internet or computer network connections. By compressing 2D images, little of the available bandwidth is needed to transfer an image for CAD processing or to receive results. Processing 3D data may be more bandwidth intensive.

The customer receives case data and collates the data until sufficient data is available. The data is prepared for transmission to the CAD service. For example, the customer computer 12 requests a gateway machine for a location to which to upload a case (patient data) and notifies the gateway when upload is complete. Task processor machines of the interface 14 take waiting uploads from the gateway machine and processes the uploaded data. The task processor machines notify the gateway machine when the task has been completed. The customer computer 12 checks with the gateway machine or may be notified to determine if any results are available. If available, the customer computer 12 obtains the results and optionally prepares final results for the end user. For example, confidential information associated with the patient is added to the results. The customer computer 12 then delivers the output as appropriate.

The interface 14 is a communications link (e.g., wireless or telephone), network card, Ethernet, TC/IP port, or any other now known or later developed interface between a computer and a remote server or processor. The interface 14 connects with the customer computers 12 through a computer network, such as a wide area network, the Internet, the telephone, wired, land line, satellite, television, videophone, courier, wireless, combinations thereof or other now known or latter developed communications network. In one embodiment, the network includes a plurality of networks connected together through one or more communications devices. In other embodiments, the network comprises the telephone system or other direct link between each customer computer 12 and the server 18. The network may include routers, switches, or other devices for transmitting information from one or more of the customer computers 12 to the server 18 and from the server 18 to one or more of the customer computers 12. In one embodiment, the network is a high speed network with sufficient bandwidth for transmitting high resolution imaging in a manner of seconds. All or parts of the transmissions may be encrypted to ensure privacy, on either or both of link level and data level.

The interface 14 handles communications in one or more formats. The interface 14 is configured by hardware and/or software to receive patient information. The interface 14 includes one or more ports for receiving patient information representing a plurality of patients associated with a respective plurality of medical offices.

The patient information handled by the interface 14 includes any type of patient data. For example, the patient information for each patient includes one or more images, family histories, test results, clinical information, genetic information, or combinations thereof. Patient information is provided for each patient for whom CAD service is sought. Batch processing or independent reception of the patient information may be used. The patient information is free of patient identification, encrypted or both to protect the medical information for the patients. The interface 14 is also configured to communicate results from CAD to the appropriate customer computers 12. The interface 14 may route requests, such as determining a type of CAD to be applied and routing each request for appropriate processing. The request may be coded or the type of patient information is used to route the request.

Where the server 18 or the processor 20 needs more information, the interface 14 may route a request for the information to the customer computer 12. Alternatively, the request for more information is communicated over a different link. The server 18 or processor 20 may request any data to which the client has access, the data allowing processing of a request for CAD that lacks data for one or more features.

The memory 16 is a local memory for the server 18, a separate database, a bank of RAM memory, a removable media (e.g., tapes, optical storage, reel or other now known or latter developed devices), combinations thereof or other now known or later developed memory devices. The memory 16 is configured to aggregate the patient information as the patient information is received from the medical offices. Software control of the memory 16 causes the memory 16 to store the patient information in one or more formats. Any format may be used. The memory 16 acts as a repository or archive for patient information received at different times from different customer computers 12. The memory 16 is controlled by the server 18 or the processor 20 for storing information prior to processing or for storing processed results. In one embodiment, the memory 16 is scalable so that as additional patient information is saved, more information may be further accepted. Alternatively, the memory 16 stores information for a limited period or other data retention process is used.

The server 18 is a processor, group of processors, application specific integrated circuit, computer, workstation, bank of servers, server farm, bank of processors, local area network with distributed processing, mainframe computer, or other now known or later developed devices for processing data and communicating over the network. The server 18 is operable to receive patient information from different locations, such as uploaded from the memory 16. The server 18 is further operable to process the patient information, such as applying one or more CAD algorithms. The same or different processors are used for receiving and processing the information.

The server 18 is configured by software to apply one or more computer assisted detection processes on the patient information. For example, the server 18 filters and extracts features from patient information. The features are used to diagnose, such as using a machine learned CAD algorithm. The server 18 is configured to transmit results output by the applied process to the respective medical offices.

Where updated, modified, or different CAD processes are available, the server 18 may apply those processes. The server 18 is programmed to apply any desired CAD process to subsequently received patient information and/or previously stored patient information.

The server 18 may be configured to provide other services. For example, the server 18 detects undesired operation associated with the patient information. For example, an image is filtered, template matched, or otherwise processed to determine whether the image includes the appropriate information. If not, then the server 18 indicates undesired operation of the imaging system.

In one embodiment, the server 18 is owned and operated by the CAD service provider. In other embodiments, the server 18 is a third party server of a server farm or other collection of servers. The developer of the computer assisted detection processes rents use of the server. Any payment scheme for server usage may be provided. Rent of a server is used herein to indicate payment for use of the server without current ownership. The CAD service provider uploads or provides the CAD processes for application by the server.

The CAD servers 18 may be run in a hosted environment (e.g. Amazon, or Microsoft). On-demand hosting charges only for any time servers are really used. No minimum use may be required, but any arrangement may be made. The CAD service may be started and/or provided without substantial server investment. The third party host may provide APIs, storage, failsafe, and other data center operation, so little or no development for the operation of the servers or data center is required. For example, the server provider may already provide load balancing. If the hosting provider or server 18 goes down despite high an uptime promise, the client may be able to switch between different hosting providers automatically.

As an alternative or in addition to automated processing by the server 18, the server 18 includes a display and a user interface for processing at least in part in response to user input. The display shows the patient data received from one or more of the customer computers 12. The user input receives diagnosis information from a user and provides the diagnosis information to the server 18. For example, one or more images are displayed. As part of the CAD service, a sonographer, cardiologist, radiologist, or other trained personnel view the image and suggest a diagnosis, an area for further study, a surgical procedure, processing to be performed by the server 18, processing to be performed by one of the customer computers 12, identify borders, identify defects in scanning, provide input to the CAD algorithm, or enter other information. The server 18 may assist the trained personnel by processing the data and suggesting options. The information is provided to the server 18 for either further processing or routing as processed results to the appropriate customer computer 12. In one embodiment, a user controls a process implemented by the server 18 or by a different processor. The processed information is then provided to or by the server 18 for transmission to the appropriate customer computers 12.

The processor 20 is a general processor, digital signal processor, server, application specific integrated circuit, field programmable gate array, digital circuit, analog circuit, combinations thereof, or other now known or later developed processor. The processor 20 is part of a computer, workstation, or other device for developing a CAD process and/or controlling the operation of the server 18.

The processor 20 is configured by software and/or hardware. The processor 20 is configured to machine train computer assisted detection processes. Any machine learning approach may be used. A training data set labeled with ground truths is used to select features, weight features, or otherwise process features to determine an outcome best matching the ground truths. The training data set includes a plurality of instances, such as hundreds or thousands of samples. A computer applies a neural network, Bayesian network, or another process to reliably predict an appropriate diagnosis based on input data for future or different samples. The features from the patient information used in the machine learning may be selected and/or influenced by the developer. Filtering or feature extraction approaches (e.g., type of calculation to use from an image) may be provided by the developer. Any now known or later CAD process may be developed. As the interface 14 receives each medical image or other patient information, a size of a training dataset for the machine training of the computer assisted detection process increases. In alternative embodiments, the CAD process is developed without machine learning, such as using features or other information known to have a sufficient correlation with the result.

In one embodiment, the patient information stored in the memory 16 is used for developing CAD processes. The current CAD process or algorithm may be modified or otherwise improved by an increased training data set. The patient information, such as images, is used as a training dataset for the machine training. The patient information may not include a result or ground truth. The patient information may be used for testing, an expert may indicate the ground truth for one or more samples from the patient information, and/or the ground truth may be mined or requested from the customer computer 12. The processor 20 is configured to machine train with ground truths for the patient information. Alternatively, the ground truths may be implied. For example, a condition or result is inferred from subsequently received patient information. For example, a subsequently acquired test result and/or image indicate that the previously provided patient information is positive or negative for a condition. Based on having received subsequent information (e.g., medical images) for the same respective patients, the ground truth is indicated. Coding, such as an identifier, is used to track the patient and/or medical facility.

The processor 20 is operated by the service provider to provide a CAD process or processes for application by the server 18. The CAD process currently applied may be updated based on further training. The same type of CAD process is provided, such as a same type of machine learning algorithm for a same condition. Alternatively, the type of CAD process is altered to diagnosis a same condition. In another embodiment, different CAD processes are provided for different types of patients (e.g., based on age or residence) but a same condition. The patient information from geographical, age, or organization-based ranges is used to train CAD processes. CAD processes for a same type of diagnosis are provided, but each is trained for different ranges of criteria, such as a different CAD process being applied to detect breast cancer for different age groups. The increased size of the training data may allow for group-based optimization of the CAD.

The updating of the CAD process using patient information may occur on an ongoing basis with or without full automation. For example, the processor 20 actively learns with machine training as the patient information is received. The original or most recent training data is updated to include the later received patient information and ground truth. The CAD process is relearned or modified based on the new patient information. Due to the active learning, updated or modified CAD processes are provided to the server 18 for application on a regular or periodic basis.

The processor 20 may train and make available for application by the server 18 CAD processes for different conditions.

The performance of the CAD processes may be tested. The testing may use patient information stored in the memory 16 or other patient information. The CAD process for a given condition or set of criteria may be selected and provided to the server 18. The updates, new CAD processes, performance testing or other aspects of CAD development is based, at least in part, on the patient information made available by providing the computer assisted detection process as a service to the medical offices.

The processor 20, server 18, interface 14, and/or customer computers 12 may be configured, at least in part, by instructions stored on computer readable memory. The computer readable memory may be a memory local to the device, a remote memory, or the memory 16. The instructions are for accessible computer assisted detection. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

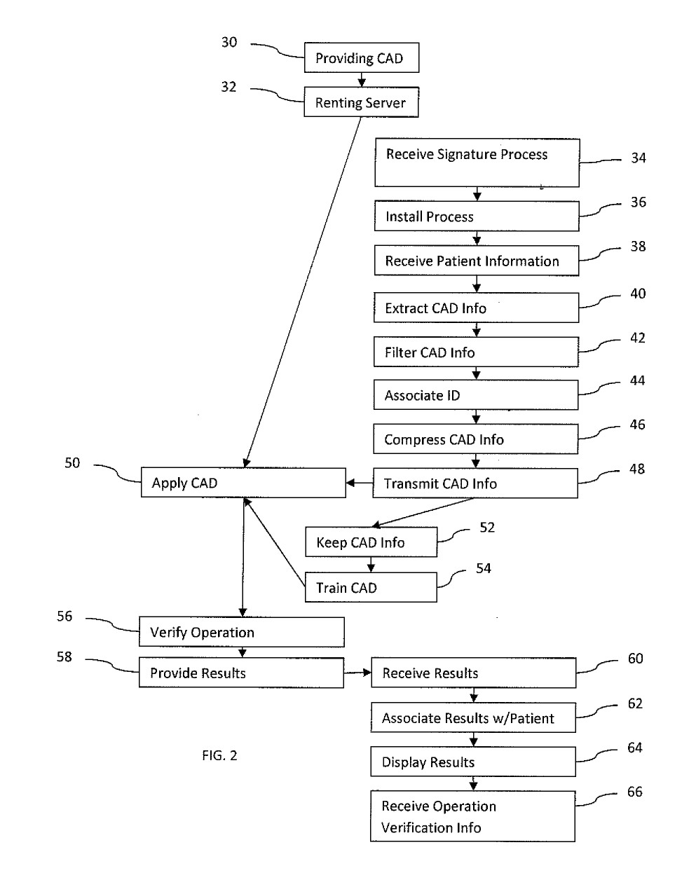

FIG. 2 shows one embodiment on a method for accessible computer assisted detection. The method uses the system of FIG. 1 or a different system. Additional, different or fewer acts than shown in FIG. 2 may be used. For example, the acts are distributed in three columns. Each column corresponds to acts performed by a different entity, such as a customer computer (right column), a third party server (left column), and a CAD developer (middle column). One or more acts may be performed by a different entity, such as the CAD developer performing the server or application related acts 50, 56, and 58 or such as the third party server performing act 52. The acts performed by a given entity may include additional, different, or fewer acts. For example, the filtering and/or compression acts 42 and 46 may not be provided. As another example, the verification of operation acts 56 and 66 may not be provided. Acts associated with different aspects may not be provided, may be provided alone, or may be combined, such as providing the extraction act 40, training CAD act 54, verification of operation act 56, and renting act 32 alone or in any combination.

In act 30, a computer assisted detection algorithm is provided. The computer assisted detection algorithm is configured to detect a condition of a patient or other information from patient information. Any patient information may be used. Any CAD algorithm may be used. The CAD algorithm may be for detecting any condition, such as lung or breast cancer. The CAD developer acquires or creates the machine learnt matrix or other CAD program. One or more CAD algorithms are provided for application as a part of a remote service.

In act 32, the CAD service provider arranges for one or more servers to apply the CAD algorithm. Any arrangement may be made, such as the CAD service provider purchasing a server and hosting the application. In other embodiments, the server usage is rented from a third party. For example, the CAD service provider rents a server farm and/or servers in different regions to apply the CAD algorithm. The rent is on-demand or as needed. If more customers request application, then more server processing or usage is provided. The amount of money due to the third party for the server usage may vary with the amount of usage. For example, “on-demand” hosting from Amazon or another operator of one or more network available servers is used to apply the CAD. In this hosting model, the customer (e.g., medical professional) or CAD service provider pays for the hours or processing used. Storage servers are used for transfer of data to and from the customer. On demand hosting may operate more efficiently due to the data storage capability. For operating the data center, sufficient computer time to handle peak demand is purchased and operated. To avoid idle processing power, using the third party server farm or data center with “on-demand” hosting is provided. In on-demand hosting, more or less computers are used as needed. For example, Amazon may not require any minimum fee. Elastic Cloud (EC2) or other network may be used for processing, and Simple Storage Service (S3) or other network may be used for data storage and transfer. SQS or other process may be used for managing the queue of cases needing to be processed by the servers. Other versions may be able to connect to comparable services from other companies. Another version uses two or more different third party server providers for fallback in case of system failure by one server provider and/or optimizing costs.

Other arrangements than on-demand may be made, such as including minimum or maximum usage or rent, or providing for payment of a set amount of server processing. Renting or providing a server connected with a computer network allows CAD to be provided as a service. The customer or medical professionals may have access to CAD without software licenses and/or hardware purchases. Instead, a CAD service provider applies the CAD to images or other patient data from the customer.

Any billing of the customers may be used. For example, the customers (e.g., medical professionals, medical offices, entities associated with the customer computers requesting service, or those arranging CAD for them) are billed based on a yearly subscription fee per site, per system or per site and system. As another example, the customers are billed based on usage. The number of cases, the number of acquisition (scanning/imaging) systems, or both may determine rate or amount of usage. Combinations of yearly or usage may be used. Charging for time to process, bandwidth, or data size may be used. Some cases are processed very quickly by CAD algorithms, others take a lot of time, so a customer may prefer case-based or yearly billing. Another option is to have the CAD service bundled by the manufacturer of an imaging system. The manufacturer may pay the CAD service provider for their customer's usage. The CAD service may be bundled for redistributors, who choose their own model. The redistributors may be charged a fixed price per case or other arrangement may be made.

The cost to the CAD service provider may be relatively small. For example, costs from the server provider, including temporary storage during processing transfer in and out, may be based on the market for server processing and memory. CAD service per case may be offered cheaply, especially in comparison to purchase of a CAD system.

In act 34, the CAD service is made accessible to the customer. A signature process is received. The signature process manages provision of data to be used by a CAD algorithm from a customer. For tracking data from different customers, the software establishes a site identifier (most likely digital signature) for sending data to a storage server for processing. Alternatively, a digital signature system is used to track data from different customers. The signature process is a program, link, software, and/or hardware for accessing the CAD algorithm by the customer. The signature process gathers the patient information. Gathering may be provided by manual upload of data, direct entry of data, mining of a database (e.g., mining a hospital patient database), archive retrieval, combinations thereof, or other process for making patient information available. The signature process links to the server or remote CAD algorithm to communicate the patient information and to receive the results. The link is through a network, over a phone, or other data link. The signature process provides a user interface or uses available user interface software to establish a link, gather data, transmit data, use results, or otherwise interact with the CAD algorithm and the customer. The signature process may be one program or may be a combination of programs, including general use programs, such as a web browser.

The signature process is received from a computer assisted detection service. The signature process originates from an entity other than the customer, so is obtained remotely from the CAD service. The process is provided directly, such as from the CAD service provider with an Internet download, or indirectly, such as through an imaging system manufacturer or other company. The software may be distributed on CDs, Internet download, service update packages, or other sources. The signature process is received on a hardware device, such as on an imaging system or other customer computer. The CAD service may be provided with any imaging modality. The signature process may be received on a memory device, such as a memory stick, a portable hard drive, optical media, or other device. The signature process may be uploaded or downloaded, such as receiving software over a computer network.

In other embodiments, the signature process is received as data for a web browser program. Since most customers can use the Internet from their institution, connectivity is provided without the perception of a need to have expert installers. The client may only use HTTP or HTTPS from the client to the server. The client may not need incoming connections from the Internet or other external machines. The client behaves like Internet Explorer.

The signature process may emulate imaging or PACS software. Since radiologists operate with different imaging modalities, providing the CAD service in a same format but for different types of medical imaging may be useful. The radiologists may be comfortable with the same format.

The setup costs may be low. The customer merely navigates to the CAD service on the Internet or over another network. Alternatively, free or for purchase software is provided to the customer. The customer's information technology group or service configures one or more computer using the software. This may avoid paying for a workstation manufacturer technician to install the workstation. Setting up a CAD system at a customer site may be comparatively expensive, where a high end PC is purchased and a service installs the CAD system. Server provided CAD may use a simple piece of software that is installed at the site by the CAD user. No or little investment is required for setup. Alternatively, a service installs the software and/or hardware is purchased.

The signature process is provided with an expectation of payment. Yearly customer realized price of the subscription may be very low. The customer realized price is the price the customer really pays on average for a product, not the list price that is often much higher. Any billing approach may be used, such as by amount of processing, number of requests, yearly license, or combinations thereof.

Given the ease of installation of software, trial licenses may be provided. Trial licenses may be implemented any way. In one trial license, data is sent to a server by a customer/client. Data is only checked by the processing server against a list of approved clients based on subscription type at data reception and/or at processing time. The data is always transferred, but a check is done after full transfer. In another trial license, the client provides site identification and type of data description to the server before sending to the storage server. The server checks whether the client is allowed at this time. Only data that will be processed is received by storage server. Alternatively, other data is received. This may prevent high costs for systems without valid subscriptions. In another trial license, the client has a license/subscription file (e.g. using FLEXIm or others supporting other models). The client checks against that license file. The client only creates patient information for CAD analysis if the license check is positive.

Revenue may be provided to any entity associated with the CAD service provider, such as manufacturers of imaging modalities or PACS systems, OEMs, the CAD service provider, or others. For a PACs manufacturer, the CAD service may be integrated with the PACs system, such as integrating the client into Syngo Imaging and Access. The CAD service provider provides the client software to the PACs manufacturer for use or for deep integration. In deep integration, the client will no longer receive images via a DICOM node, but directly from or via the PACS. The configuration is done via the PACS configuration mechanisms. Providing the CAD service client software on the PACs systems may allow offers of free trials to all customers or provide bundling at very low cost.

Similarly, the CAD service client may be provided with any acquisition, imaging, or detector modality system. Any company (e.g., OEM) making x-ray systems, mammography systems, CT systems, MRI systems, ultrasound systems, or other modalities are provided with the CAD service client. The client may be loaded onto existing systems, such as during a service call, and/or provided on new systems. In exchange, the OEM may get a percentage of the CAD service profits or revenue. There is little risk to the OEM, no complex maintenance issues, and a cost effective CAD solution is provided to their customers. The same arrangement or a different arrangement may be provided for any workstations or imaging system provider.

Several different services might be provided to the same client (e.g. mammography CAD, chest x-ray CAD, and monitoring for X-ray system performance). All of the services might have separate subscriptions even based on different models, or the subscriptions might be provided in a bundle.

In act 36, the signature process is installed on a local computer. The local computer has access to patient data, such as through a network, memory transfer, archive retrieval, or other source. Any local computer may be used, such as a personal computer or workstation. The installation configures the signature process and responsive computer for operating with the CAD service.

In one embodiment, basic software is installed at the customer site. This client is run as a local DICOM receiver node. In DICOM receiver node Acquisition systems, PACS systems, or others, communication is handled via DICOM, so are therefore DICOM nodes. Since the client is a DICOM node, the system is compliant with many hospital environments. The customers configure the acquisition workstations to forward the images or other patient information to the client software or DICOM receiver node. Once the client has the CAD results back from the server, the results are forwarded to the configured destination. The appropriate destination may be a hospital information system, electronic health record (EHR), configured DICOM node (e.g. PACS system, mammography reading workstation or other output device), or combinations thereof. The client may be alternatively directly integrated into an acquisition system or a PACs system rather than implementing a DICOM node. This deep integration may make configuration easier.

Since the CAD service is provided on servers, an Internet accessible system may be provided. The CAD service may be offered anywhere Internet access is available, such as even at a radiologist's home. Web-based viewing of results is provided. The images are displayed with the CAD results to the user.

After installation, the software may be able to update itself when contacting or being contacted by the storage server used for receiving patient information from the site. Enhanced compression systems or different output format support may be provided. Different compression, output formats, or both may be provided to the client. For example, different functionality options are available for initial install or later upgrade. Based on the user's need, cost, or performance considerations, the user may update or initially install to the desired functionality.

After installation, the signature process is used to acquire patient information. The acquisition occurs at any of the customers. In act 38, the patient information is received by the customer or signature process. For example, an image is acquired. Any type of patient data may be acquired. The patient information is acquired using any now known or latter developed techniques, such as imaging, laboratory tests, patient interview, physician notes, or other approaches. The data is manually entered or retrieved by a processor. For example, a patient record is data mined. The patient information may be acquired from storage or previous visits or may be acquired during a current or on-going visit. The patient information may represent data acquired at different times, such as a sequence of images or a video.

In act 40, the signature process extracts computer assisted detection information from the patient information. Only a subset of the patient information is to be transmitted to the server of the CAD algorithm. For example, information associated with the patient is extracted so that data identifying the patient is not transmitted. The data to be transmitted is free of the patient identity. The extraction strips the patient data of patient identity information and/or at least some information not used by the computer assisted detection. The extracted patient information is sent to a central server for processing. No full DICOM image or any other privacy sensitive information ever leaves the site. Some images may include patient identification within the image, such as an analog x-ray with a patient or customer identification burnt into the image. The image may be analyzed to mask out such information. The data may or may not be encrypted.

The extraction may select patient information used by the CAD algorithm and not other information. Different CAD algorithms may use different inputs or features. At least one image or other information for the patient is maintained in the patient data. The information to be used by the CAD algorithm is maintained. In other embodiments, only data to be transmitted is received in act 38 so that further extraction is not performed.

In one embodiment, the client (signature process) extracts a CADImageSignature from a DICOM or other image. A DICOM image contains information in the header about the patient, acquisition parameters and other data as well as the image pixel data. The CADImageSignature is to be transferred to the servers for processing. The CADImageSignature may just contain the pixel data and some image technical acquisition parameters. The patient identity is stripped from the DICOM image. The client extracts a CADImageSignature from DICOM image. The extraction may take any amount of time, such as less than <1 sec per image. In one example, the image is segmented to provide just the regions of interest (e.g., in mammography, just get the breast tisues, or in chest x-ray, just get the lung tissue). More or less processing may be performed at the customer location, depending on the computer capabilities.

The CAD algorithms implemented by the server are optimized to run well on the information in the CADImageSignature. Any other process may be used. The creation of the CADImageSignature minimizes the data while allowing the CAD algorithm to run well. The extraction to maintain the desired information may be performed by the client in a local DICOM receive node.

In alternative embodiments to operation as a DICOM node, other file systems may be used. For example, hospital information systems, such as HL7, patient EHR, or others, are used. The signature process operates pursuant to the appropriate information system. The results of processing may go to a DICOM node, the information systems, or any combination of the above. Data may come from multiple sources and go to multiple sources, including DICOM nodes and hospital information systems.

The extraction of patient information may also be optimized or constrained to limit processing expensive calculations on the client side. The client may be run on any type of computer (low memory, slow processor, other real-time constraints, or server busy with other things). In order to facilitate support and quality assurance of the CAD application and/or support further developments, more information may be transferred in the CADImageSignature than required by a current CAD algorithm to output results. In other embodiments, all of the available patient information is extracted for transmission. In yet other embodiments, all of the non-identifying patient information is extracted for transmission.

The patient information for transmission may be digitally signed and encrypted. The transmission may occur over SSL. One, more, or none of these approaches may be used to protect the security of patient information. The stripping of patient identifying information may or may not be used with these other sources of secure transmission.

For authentication, a secret key and “password” over the SSL connection may be used. The signed data also confirms the identity of the sender. Any one of the above is sufficient for authentication, but a combination may be used.

In act 42, the patient information is filtered. The filtering occurs prior to transmission. The CAD algorithm may operate better on filtered information. To reduce processing by the server applying the CAD algorithm, the signature process may filter or otherwise process the computer assisted detection information. Other processes include extraction of input features. The filtering or processing may remove or reduce non-relevant parts of the patient information. Some filtering is performed at the client site or by the client computer (e.g., perform a basic Gaussian smoothing to remove noise). The filtering may make compression more effective. Non-used bits may be removed (e.g., mammography images often are stored in 16 bits but only use 14). In alternative embodiments, filtering or other processing is not performed by the signature process or at the client site.

In act 44, an identifier is associated with the patient data. Since the patient identifying information is removed, a substitute signature or identification is provided. The identifier allows the signature process to associate results with the proper patient, allows identification of the customer, allows identification of the customer machine, or otherwise provides coding for billing or other tracking purposes. The identifier is random or coded in accordance with a formula, or both. For example, a portion of the identifier indicates the customer, computer, medical office and/or facility, and another portion is randomly assigned for the patient. The identification and patient association is stored at the customer site and not transmitted. The assigned identifier is unrelated to the data identifying the patient. As an alternative to random assignment, a sequential number may be used. Each subsequent request is assigned the subsequent number. The client generates a unique identifier for each case and makes the identifier part of the CADImageSignature or otherwise relates the identifier to the patient information. When the server sends back the results, the results are associated with the identifier, allowing association with the proper patient. The identifier may also be used for billing purposes.

In act 46, the patient information is compressed. The compression is performed prior to transmission to reduce the amount of data. A compression algorithm (e.g. JPEG 2000 lossless) may be applied. The compression is lossy or lossless. Alternatively, compression is not used. The CADImageSignature may contain a compressed version of all information necessary for CAD processing.

In act 48, the patient information or information for use in CAD is transmitted. The transmitted information may include one or more images. In one embodiment, the transmitted information does not include patient identity information. The assigned identification is transmitted. The transmission may be in any format, such as TC/IP. The information is transmitted electronically, such as over a computer network or via video-transmission. Alternatively, the information is transmitted on a movable storage device, such a compact disk, memory diskette, tape or other now known or latter developed portable storage device. For electronic transmission, the data is transmitted in one of any now known or latter developed formats, such as an HTML, JPEG, MPEG, DICOM, XML, or other now known or latter developed computer network communications format for video, image or other medical data.

The transmission is to the computer assisted detection service. Where the CAD provider has rented servers, the transmission is routed to the appropriate server farm for on-demand provision of CAD. The patient information from one or more locations, such as any customer of a CAD service, is transmitted from the respective clients to one or more remote central server locations. The central location is in a different facility than all or a subset of the various customer locations.

The server receives the patient information. The receipt alone acts as a request from customers for computer assisted detection. Alternatively, a separate request or verification of the request is provided. The server receives requests from one or more locations, each associated with one or more patients. The patient information is separate for each patient, but may be in a batch for patients from a same facility or customer. Since different customers request CAD service, the received patient information is associated with different locations, patients of different ages, different organizations (e.g., hospital groups), or other grouping of patients. The patient information, such as medical images, is free of patient identity, but instead includes an identifier that does not indicate the patient without a table unavailable to the server.

In one embodiment, the CADImageSignatures are received at the servers. The host implements identification and receiving services. The CADImageSignatures are decompressed and/or decrypted. The CAD service provider provides CAD software for the server to implement. The CAD software processes the CADImageSignatures. The total hosting cost, depending on business plan, may be low, depending on volume and offered CAD algorithms (e.g., CXR and MammoCAD combined).

The received data is queued for processing in the order in which the data is received. In alternative embodiments, data from one or more of the plurality of facilities is provided with a priority. The received data from a plurality of remote locations is queued for subsequent sequential or parallel processing. For example, the server receives a plurality of data sets over a computer network over a short or long time period. Once a complete data set is received, the data set is labeled with an identifier for a position in a queue for further processing.

In act 50, a processor applies the computer assisted detection to the patient information, such as images. The processor is part of the server or another server. For example, one server manages data routing and/or queuing and another processor applies the CAD algorithm. Any processor in the server farm or other processor rented from a third part applies the CAD algorithm. Alternatively, a processor owned or controlled by the CAD server applies the algorithm. The number of requests determines the amount of server usage. A server farm may allow for increasing use demands or peak use times.

The service provider has control of the server network and may allocate jobs to various task processor machines and sub-groups as desired. This central control may use a database or SimpleDB (or alternative) for control and configuration of the network of machines. The service provider has central control of how jobs or requests are processed. Different algorithms or versions of a same algorithm may be selected as appropriate for the patient information or request. The service provider controls what gets processed, both in priority and which sections of the sent data are be processed. The control allows optimization of economies of scale by aggregating the different requests on a central server or servers.

The client may send different requests to different locations, such as a request for a mammography CAD to one location and a lung cancer CAD to another location. Different vendor algorithms may be used. Alternatively, a case may be sent to one server where different vendor software may be run. In another alternative, the case may be sent to different sets of machines for reliability of service. When different vendors are used, it is possible to aggregate the results or to get a single better result from multiple opinions.

In one embodiment, the server automatically processes the request without user input at the server. For example, the server receives image information from a plurality of customer computers. The same or different processes are performed by the server on the received imaging information without human intervention. As another example, one or more processors of the server are operable to process imaging information based on a characteristic of other images. Received imaging information is compared with one or more other images associated with a particular diagnosis or feature. The server identifies a similarity or dissimilarity from expected images.

The processor extracts the desired process to be performed from the received data as a function of a coded header or a type of information received. The process is then performed with a processor, such as providing a particular type of filtering, quantification, or other processor implemented algorithm. For example, a more up-to-date, efficient, complex, thorough or otherwise different process is performed by the central location than is available at the locations where the data is acquired. New technologies for processing and the state of the art performance of the processing may be more likely available to the central location than to individual remote locations. Financially and/or intellectually disadvantaged medical offices or other facilities capable of acquiring patient information may take advantage of more advanced processes performed at the centralized location.

In an alternative embodiment, some user input is provided at the central location for performing the processing. For example, a user views the acquired data and indicates a type of processing to be performed by a processor. As another example, the user indicates that a requested process should be performed. As yet another example, a user performs some or all of the processing by entering diagnostic information. The patient data is displayed. The user at the central location enters diagnostic information with a user input. For example, a diagnostic conclusion is entered. As another example, highlighting for a particular location of an image with or without further annotation is entered. As yet another example, a mere acknowledgment of, agreement with or disagreement with another opinion is entered. As another example, surgical planning information, such as the type of equipment, how to use the equipment, when to use the equipment and where to use the equipment during surgery is entered. The entered information is processed data provided in response to the received information. Medical professionals are able to assist medical professionals at other locations. Alternatively, engineers or others familiar with medical processes are able to distinguish process artifacts from areas of medical concern.

In act 52, the received patient information is stored. The information may be stored by the third party server and/or by the CAD service provider. The received information is kept in a database or other memory structure. Where different servers receive the patient information for different patients, the data may be separately stored or aggregated into a fewer number of locations. By keeping the patient information, a number of samples associated with a medical condition increases as more requests or patient information are received. The aggregated data is stored in any desired format. The aggregated data may be available as a training data set for training a CAD algorithm, such as for creating an entirely new CAD algorithm or updating a current CAD algorithm. In alternative embodiments, the received patient information is not stored beyond a time limit and/or after transmitting results.

In act 54, a CAD algorithm is trained. A processor trains the CAD algorithm with machine learning. Any machine learning, with or without user optimization or control, may be used. Since patient data, such as images, is provided from the customers to the servers, an enormous amount of data is available for further development of CAD algorithms. The data is used as a training dataset without requiring extensive and expensive clinical studies. The training may also use information from clinical studies.

The CAD algorithms may be productized or provided for use with less cost. Automated testing by the servers running thousands of cases very quickly minimizes cost. All new cases can be run on an old algorithm and new algorithm in parallel for some time before release to customer using the servers. Deployment is made easy by uploading a new server image once. The software to process images and the CAD algorithms are uploaded to the servers or data center. On demand hosting infrastructure may automatically propagate the server image without further tools from the CAD service provider.

For training, the samples or requests may not be associated with a ground truth (e.g., biopsy results). The ground truth may be determined by a medical professional (e.g., a radiologist reading the case), requesting the information from the customer, mining the information with a processor, and/or assuming a ground truth. Radiologist calibration using a resource of previously unavailable image data for CAD algorithm development is provided. The amount of data may compensate for the lack of ground truth.

The ground truth may be assumed from subsequent requests for CAD application. For example, a first requested is received for a patient. The first request is for application of a CAD algorithm to a chest x-ray image. A subsequent request is received for the same patient for application of a CAD algorithm to a chest CT image. The assigned identifier is used to determine that both requests are for the same patient. The subsequent request for CAD service on a chest CT indicates that the chest x-ray indicated a concern or condition, showing a positive ground truth. A chest CT is not typically ordered unless the chest x-ray indicates a problem. Similarly in mammography, a first request is of a standard set of four x-rays or CC-MML image set. If a later request includes a magnified or spot compress image, then the original set indicated a concern or condition. Other follow-up imaging or requests may indicate the ground truth for a previous request.

Since a large amount of data is available, the CAD algorithms may be developed for many different patient groups, such as algorithms optimized for different age groups. The computer assisted detection algorithm may be trained for application to subsequent patients for different age ranges, location regions, organizations (hospitals), or combinations thereof. The large amount of data may be used to create localized CAD algorithms. The CAD algorithms may be refined based on region (e.g., different algorithms in Europe than in the USA). Due to the amount of data, the algorithms may be specialized for specific areas (E.g. MammographyCAD for Asia) and/or sub-populations. The training data associated with a given group is used to train for that group. The available groupings may be determined from examining the aggregated data. Where more training data is available for a particular grouping, a CAD algorithm specific to that group may have more demand. The refined or group specific CAD algorithm may further increase use of the CAD service and better meet customer desires.

The aggregated data may also be used for other purposes or by other entities. For example, data associated with one or more groups is sold for use in a clinical study.

The training of act 54 may be for creating a new algorithm or for updating of an already existing CAD algorithm. To update an already existing CAD algorithm, active learning is used. As new data is received, the data is used to modify the appropriate classifiers. Any amount of data may be used, such as modifying after one, ten, hundred or other number of patient samples with ground truth is received since the last modification. The CAD algorithm evolves or improves over time. Large amounts of data storage are not needed as the algorithms learn as the data is received. Hybrid models with only part active learning might be used.

The patient information may be used to verify operation of any CAD algorithm. Scientists develop the CAD algorithms. After development, the algorithms are tested and must fulfill regulatory requirements, including documentation of the requirements and testing. Having many servers available, testing may be performed rapidly. This may allow release of an algorithm rapidly (e.g., within two weeks) after the scientists finish their work and still fulfill all Q, CE, or other requirements. For example, images from requests may be used to develop a new algorithm and/or to test the new algorithm or version of the algorithm.

In addition to or as an alternative to training for a diagnosis conclusion, an algorithm may be trained or created to provide further information to assist in diagnosis. For example, the CAD algorithm outputs a conclusion and/or markers of suspicious locations. The same or different algorithm may identify the most similar cases, allowing consultation and/or review of outcomes given different treatment strategies. In one embodiment, image retrieval-based detection algorithms are provided. A whole image or a section of an image received with a request is compared to other known images. Alternatively, the comparison is of one or more features or other data sources. If there is a match, the algorithm looks up the diagnoses for the known image or data and uses that in the decision process. Having an ever-increasing database of images may allow for ever increasing availability of matches and/or matches with greater numbers of common factors. The many servers may be used for more efficient or rapid searching for matches. Searching in parallel on many servers allows each server to compare the new image to a limited set of reference images in the local memory.

The similarity may be indexed, such as indicating a degree of similarity. The similarity index is provided by processing the information to determine its relationship to the collected cases. The index of similarity may include an assignment of probability. For example, a tissue of interest is identified as more or less probable to be a tumor. Other cases or one other case with a high similarity may be identified. The index of similarity is based on correlation, neural network, filters, or other now known or latter developed algorithms for identifying a relationship of one set of information with other sets of information.

After each algorithm is updated or modified, or after a new algorithm is created, the CAD service provides the algorithm for application in act 50. The CAD service merely provides the upgrade or replacement to the server host. The customer may have the latest version of the software available or potentially choosing an older version without having to pay for an upgrade or have the hassle of installing upgrades. No high-end system or workstation is needed for computations at the customer site. The CAD service provider offers a low cost service. CAD may be provided for any radiologist with a computer and a network connection with little or no requirement for purchasing software or hardware. The availability of a new or updated algorithm may be communicated to the customers using the same communications as the patient information or separate communications.

The servers and CAD service provider may perform other services using the image information. In act 56, the operation of a medical imaging system or other data collection of patient information may be verified. Acquisition system monitoring algorithms may be provided. Image quality is automatically supervised.

Imaging performance may be monitored to determine an error associated with acquisition or processing of an image. For example, the CAD results are monitored. Cases or sites that have too many marks may be identified. CAD algorithms may not perform well on noisy cases. For mammography, CAD algorithms may have difficulty with dense breasts or cases that also have other pathologies. The large number of marks may indicate a need to improve the CAD algorithm or image acquisition.

Other indications of improper operation or errors in patient information may be used. Image artifacts may be detected, image settings may be compared to desired ranges, or combinations of number of marks, artifacts, and settings may be used. For example, the servers may examine images for detector artifacts or AEC malfunction. Problems of the detector (scanner) might show up as lines in the images with a different intensity or patterns of pixels which are less sensitive (e.g. due to crystallization). Poor operation may be detected by analyzing the single image with image processing algorithms.

In another embodiment, a sequence of images from a same imaging system, operator, or both are compared. Comparison to previous images checks if changes have occurred. Any number of images, such as the 100 last images, may be used. In that way, small changes with respect to the signal-to-noise ratio in a single image may be detected even using the normal QC procedures that sites have to do regularly. Differences associated with degraded performance of the imaging system may be detected, such as identifying a decreasing average brightness or dynamic range. Aggregation of data may be used to describe similarity and commonality for a given operator or machine. The quality of operation and machine may be described or proscribed. For example one operator may generally over-expose images or improper position the patient.

Automatic exposure systems (AEC) make sure that parameters are set in such a way that one gets the best image possible. If there are problems, the image may look overexposed, or underexposed, or there may be areas with very low or too high contrast. For example, the right angle may be determined by segmenting the ribs in a chest x-ray. An image should be taken from the middle, and not form too high or too low, or off center. In mammography, there should be a fixed ratio of tissue covered between a CC and an MLO view of the same breast. The amount of tissues covered for the right and the left breast should be similar. The specific views, which refer to the position of the woman and the system together, have specific shapes in the image. The name of the view is in the DICOM header. When the image does not fit what is in the header, the positioning is not good. The algorithm may report concerns, solutions, and/or advise to the customer and/or the CAD service provider.

Having multiple servers provides sufficient processing power to monitor image quality. Problems with the detector may be identified before the customer notices the issue. This may allow planning for a solution before needed, keep higher uptimes, and keep the customer happy. Due to the ability to combine information from many images, defects are detected before becoming visible to the eye.

In addition to or as an alternative, the quality of the patient information may be diagnosed. An algorithm may learn or be machined trained to determine when either a particular end user or a group of them makes a mistake. Where the mistake is likely to have occurred, the mistake may be reported to the appropriate medical office for correction. The system may suggest when it is advised to “over-ride” an opinion in favor of the software or alternative due to a mistake in data. The system may detect common mistakes. Areas of weakness and/or reporting performance may be tracked.

The results are monitored and reported so that improvements are made where needed. Weaknesses may be more efficiently addressed since the CAD service provider has access to the results rather than just relying on customer feedback.

In act 58, results are provided. Since the CAD is operated as a remote client service for patients of customers, the results are communicated over a network or other communications link. The customers provide CAD to their patients without hardware purchases to support local application of a CAD algorithm. The local hardware is a computer for communicating with the remote CAD service. The CAD algorithm is applied by another, so a software license is not used. Alternatively, the local software, such as the signature process, is licensed.

The results are from application of the CAD algorithm, operation verification, or other results. For example, an indication of an error, poor operation, or both are transmitted. An explanation, evidence, and/or suggested corrections may be included. The indication may inform the customer that service has been or will be arranged. The indication may request updated patient information after correction. A solution to an image artifact or a recommended image setting may be transmitted.

For the CAD algorithm, a conclusion, markers, probabilities or other CAD output is provided. The location relative to an image may be indicated. Bandwidth requirements are minimized by avoiding transmission of an image with markers. In alternative embodiments, a low or full resolution image with markers is transmitted.

The results are transmitted back to the customer from whom the original information was received. The processed results may be transmitted to other customer computers as well or alternatively. Processed information is transmitted in a same or different format with or without the originally received information. All or parts of the transmission may be encrypted to ensure privacy.

In one embodiment, the results are provided in a DICOM format. For example, the server or the client creates a DICOM result file (SR, DO etc.) or other output format. The server outputs the results of the CAD algorithm: coordinates of ROIs of the CAD marks, certainty of the findings, but where appropriate also probability of malignancy, number of micro calcifications in cluster, BIRADS descriptors, optimal display parameters for ROI, and/or other result information. The client uses the results information to create a valid DICOM file. Alternatively, the server sends a DICOM file, and the client fills out the information that the server does not have (e.g. the patient name, and the unique identifiers of the study etc.).

The results may be transferred to other DICOM nodes (e.g. PACS, MammoReport). The destination node may be configured by the user, or by default, the results are sent back to the receiving node. In other examples, the results are sent to a different node. The image data is received from an acquisition system and the results are routed to PACS or reading workstation. Communications to the server are performed using HTTP, HTTPS, or other protocol (e.g., ftp), so may be handled over existing IT infrastructure.

The CAD service may use less than 9% of a 1 Mbps connection to provide image data and results.

| | | | | | |
|---|---|---|---|---|---|
| Bandwidth of dataline: | 1 | Mbps | | | |
| Bandwidth of dataline: | 429 | MB per hour | | | |
| Calculations are based on | | | | | |
| use of the system for only | | | | | |
| 8 hours a day | | | | | |
| Data per case: | 10 | MB | Data per case: | 5 | MB |
| Cases per hour | 10 | | Cases per hour | 10 | |
| Bandwidth required: | 100 | MB per hour | Bandwidth | 50 | MB per |
| | | | required: | | hour |
| Bandwidth used for CAD: | 23% | per hour | Bandwidth used for | 12% | per hour |
| | 8% | per day | CAD: | 4% | per day |

The results are retrieved or received in act 60. The results from application of the computer assisted detection to the computer assisted detection information or patient data is received. The results are different than the transmitted computer assisted detection information. For example, clinical data and one or more images are transmitted as a request to the CAD service. After application of the CAD algorithm, marker locations, a processed or modified image, probability information, or combinations thereof are received. The processed or modified image may be modified to indicate markers. Alternatively or additionally, the image may be filtered or processed to better indicate particular information associated with the detection.

The receivers can be imaging systems, viewing workstations, laptop computers, PDAs, telephones, cellular phones or other devices. The processed data is received in a same format or a different format than as the transmitted information. The identifier or other coding associated with the request indicates the destination. The identifier is provided with the results.

In act 62, the results are associated with the patient. The identifier is referenced to the patient. The results are linked with the patient. The results may be stored as part of the patients computerized medical record. The results may be matched with some of the patient information. For example, markers are matched with one of a plurality images for the patient.

In act 64, the results are displayed. Any display may be used, such as displaying on a screen or printing on a report. The display may occur during a patient visit. For example, an image is acquired during a patient visit to medical offices. A request is generated and sent to the service. The service returns the results within seconds or minutes. While the patient is at the medical office, the medical personal may review the results, reach a conclusion or diagnosis, and review the results with the patient. Further scanning, imaging, tests, questions or other medical procedures may occur, in part, based on the results without requiring another patient visit. In other embodiments, the display occurs after a patient has left.

The results are displayed in a table, chart, graph, image, text, or other format. For example, an image modified to include markers, conclusion, and/or probability of a condition existing information is displayed. The image provides the context for the results. The modified image may be based on an image provided with the request for CAD analysis or a different image. For example, the marker results are linked to an archived image. The archived image is a copy or the same as the image transmitted for CAD. The image is annotated with the markers and displayed.

In act 66, an indication of operation irregularity or other error is received. The indication may be received with the CAD results or separate from the CAD results. For example, the indication is received without CAD results if more information (e.g., another scan or image) is needed to provide the CAD results. In one embodiment, the server sends back imaging parameters and/or pre-sets to the local imaging system or other originator of the data. For example, software operable to program the imaging system with a set of parameters is provided to the local imaging system. As another example, suggested settings to be programmed, adjusted or set by the user of the local system are provided. The local user scans the patient, sends the resulting image data to the server. The server sends back processed results to implement a rescan by changing the imaging parameters.

While the invention has been described above by reference to various embodiments, it should be understood that many advantages and modifications can be made without departing from the scope of the invention. For example, different image processes may be performed at the local, remote or central facilities. As another example, different facilities may communicate over different types of networks to the same central location or server.

It is therefore intended that the foregoing detailed description be regarded as illustrative rather than limiting, and that it be understood that it is the following claims, including all equivalents, that are intended to define the spirit and the scope of this invention.

What is claimed is:

1. In a computer readable storage medium having stored therein data representing instructions executable by a programmed processor for accessible computer assisted detection, the instructions comprising:
receiving patient information for a patient;
extracting computer assisted detection information from the patient information, the computer assisted detection information being free of data identifying the patient;
assigning, to the computer assisted detection information, an identification unrelated to the data identifying the patient;
transmitting the computer assisted detection information with the assigned identification to a computer assisted detection service;
receiving results from application of the computer assisted detection to the computer assisted detection information, the results being different than the transmitted computer assisted detection information; and
associating the results with the patient by the identification.

2. The computer readable storage medium of claim 1 wherein receiving the results comprises receiving marker locations, a processed image, probability information, or combinations thereof.

3. The computer readable storage medium of claim 1 wherein extracting comprises extracting from a DICOM image, the extracting maintaining information used by the computer assisted detection and removing information not used by the computer assisted detection.

4. The computer readable storage medium of claim 1 further comprising compressing the computer assisted detection information prior to the transmitting.

5. The computer readable storage medium of claim 1 further comprising filtering the computer assisted detection information prior to the transmitting.

6. The computer readable storage medium of claim 1 wherein the instructions comprise a local DICOM receive node.

7. The computer readable storage medium of claim 1 wherein transmitting comprises transmitting to a server farm providing on-demand computer assisted detection.

8. The computer readable storage medium of claim 1 further comprising receiving an indication of operation irregularity associated with an image of the computer assisted detection information.

9. A method for accessible computer assisted detection, the method comprising:
receiving an image signature process from a computer assisted detection service, the image signature process associated with obtaining the computer assisted detection remotely from the computer assisted detection service; and
installing the image signature process on a local computer, the local computer having access to patient data;
wherein the image signature process is configured for:
stripping the patient data of patient identity information and at least some information not used by the computer assisted detection;
maintaining at least one image of the patient in the patient data;
associating an identifier with the patient data;
transmitting the patient data, including the at least one image and excluding the patient identity information, and the identifier to a computer assisted detection service;
receiving results from application of the computer assisted detection to the patient data by the computer assisted detection service, the results including the identifier but free of the at least one image;
matching the results with the at least one image and the patient; and
displaying a modified image, the modified image corresponding to the at least one image with result information.

10. The method of claim 9 wherein receiving the results comprises receiving marker locations, the modified image, probability information, or combinations thereof.

11. The method of claim 9 wherein stripping comprises stripping from a DICOM image, the maintaining comprising maintaining information used by the computer assisted detection and removing information not used by the computer assisted detection.

12. The method of claim 9 further comprising compressing the patient data prior to the transmitting.

13. The method of claim 9 further comprising filtering the at least one image prior to the transmitting.

14. The method of claim 9 wherein the image signature process is configured as a local DICOM receive node.

15. The method of claim 9 wherein transmitting comprises transmitting to a server farm providing on-demand computer assisted detection.

16. The method of claim 9 further comprising receiving an indication of operation irregularity associated with the at least one image.
